(19) United States
(12) Patent Application Publication
(10) Pub. No.: US 2009/0055026 A1
(43) Pub. Date: Feb. 26, 2009

(54) Integrated Motor Controller with Direct Networking Capability

(75) Inventors: Wai-leung Ha, Pokfulam (HK); Andrew C. Li, Laguna City (HK)

Correspondence Address: BANNER & WITCOFF, LTD., TEN SOUTH WACKER DRIVE, SUITE 3000, CHICAGO, IL, 60606, US

(73) Assignee: Computime, Ltd., Wanchai (HK)

(21) Appl. No.: 11/843,054

(22) Filed: Aug. 22, 2007

(51) Int. Cl. G05D 27/02; G05D 22/02; G05D 23/00

(52) U.S. Cl. 700/274; 318/471; 318/483; 700/278

(57) ABSTRACT

The present invention provides methods and apparatuses for controlling an environmental system with an adjustable speed motor from environmental information received through a network A network controller receives differential environmental information through the network. A motor controller, which controls the speed of the variable speed motor, obtains the received differential environmental information from the network controller, determines a desired speed of a variable speed motor of the environmental system based on the received differential temperature, and adjusts the operating speed of the variable speed motor to approximate the desired speed. The network controller further receives discrete environmental information through the network, where the discrete environmental information includes at least one measured environmental factor and an environmental set point. An environmental processor, which may be integrated with the motor controller, determines processed differential environmental information from the discrete environmental information and provides the processed differential environmental information to the motor controller.

### FIELD OF THE INVENTION

The present invention relates generally to the field of controlling a variable speed heating, ventilation, and air conditioning (HVAC) system, and more particularly to utilizing environmental information for the HVAC system.

### BACKGROUND OF THE INVENTION

With the price of energy steadily increasing, there is an increasing need to enhance the efficiency of heating, ventilation, and air conditioning (HVAC) systems. One approach to increase the efficiency of a HVAC system is to incorporate a variable speed controlled compressor in the system for the cooling function. The latest technology typically employs a sophisticated microprocessor controller unit (MCU) and a digital signal processor (DSP) to support a high performance inverter type variable speed controlled compressor. The speed (revolutions per unit time) of a variable speed controlled compressor depends on the temperature difference of the set temperature (typically set at a thermostat) and the ambient temperature of the temperature-controlled room. In general for the cooling function when the ambient temperature is higher than the set temperature, the higher the temperature difference, the faster the compressor should run.

A HVAC system is often distributed and may span a room, building, or a group of buildings. Consequently, there a need to support a distributed architecture.

### SUMMARY OF THE INVENTION

The present invention provides methods and apparatuses controlling an environmental system with an adjustable speed motor from environmental information received through a network

With one aspect of the invention a network controller receives differential environmental information through a network. The received differential environmental information is the difference between a measured environmental factor and a desired environmental factor. A motor controller, which controls the speed of the variable speed motor, obtains the received differential environmental information from the network controller, determines a desired speed of a variable speed motor of the environmental system based on the received differential temperature, and adjusts the operating speed of the variable speed motor to approximate the desired speed.

With another aspect of the invention, the network controller further receives discrete environmental information through the network, where the discrete environmental information includes at least one measured environmental factor and an environmental set point. An environmental processor determines processed differential environmental information from the discrete environmental information and provides the processed differential environmental information to the motor controller. The motor controller subsequently determines the desired speed from the processed differential environmental information.

With another aspect of the invention, the environmental processor is integrated with the motor controller in a single enclosure.

With another aspect of the invention, the measured environmental factor includes a measured temperature and a temperature set point.

With another aspect of the invention, the measured environmental factor includes a measured humidity and a humidity set point.

With another aspect of the invention, the discrete environmental information includes a plurality of measured environmental factors. The measured environmental factors is combined, e.g., by averaging the measured environmental factors. The environmental processor determines the processed differential information from the first environmental factor, the second environmental factor, and the environmental set point.

### BRIEF DESCRIPTION OF THE DRAWINGS

The foregoing summary of the invention, as well as the following detailed description of exemplary embodiments of the invention, is better understood when read in conjunction with the accompanying drawings, which are included by way of example, and not by way of limitation with regard to the claimed invention.

FIG. 1 shows a heating, ventilation, and air conditioning (HVAC) system with compressor control according to prior art.

FIG. 2 shows an integrated motor controller with direct networking capability in accordance with an embodiment of the invention.

FIG. 3 shows a network configuration of an environmental control system with an embodiment of the invention.

FIG. 4 shows a compressor/motor controller for controlling a variable speed compressor/motor in accordance with an embodiment of the invention.

FIG. 5 shows a network controller in accordance with an embodiment of the invention.

FIG. 6 shows a relationship of a determined compression speed and the temperature difference in accordance with an embodiment of the invention.

FIG. 7 shows an exemplary configuration for controlling a variable speed compressor in accordance with an embodiment of the invention.

FIG. 8 shows a flow diagram for a compressor/motor controller in accordance with an embodiment of the invention.

FIG. 9 shows a first flow diagram for an environmental processor in accordance with an embodiment of the invention.

FIG. 10 shows a second flow diagram for an environmental processor in accordance with an embodiment of the invention.

### DETAILED DESCRIPTION OF PREFERRED EMBODIMENTS

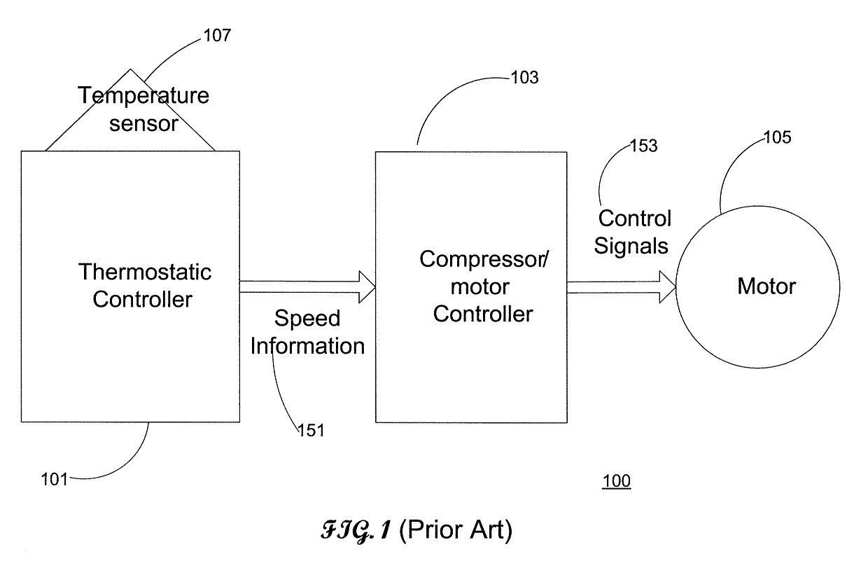

FIG. 1 shows a heating, ventilation, and air conditioning (HVAC) system 100 with compressor control according to prior art. Motor/compressor controller 103 receives either ON/OFF information or speed information 151 in order to drive motor 105 in accordance with control signals 153. With HVAC system 100, thermostatic controller 101 processes temperature information from temperature sensor 107 (typically in close proximity with thermostatic controller 101). The output of thermostatic controller 101 either directs ON/OFF signal to compressor/motor controller 103 or speed information 151 to compressor/motor controller 103.

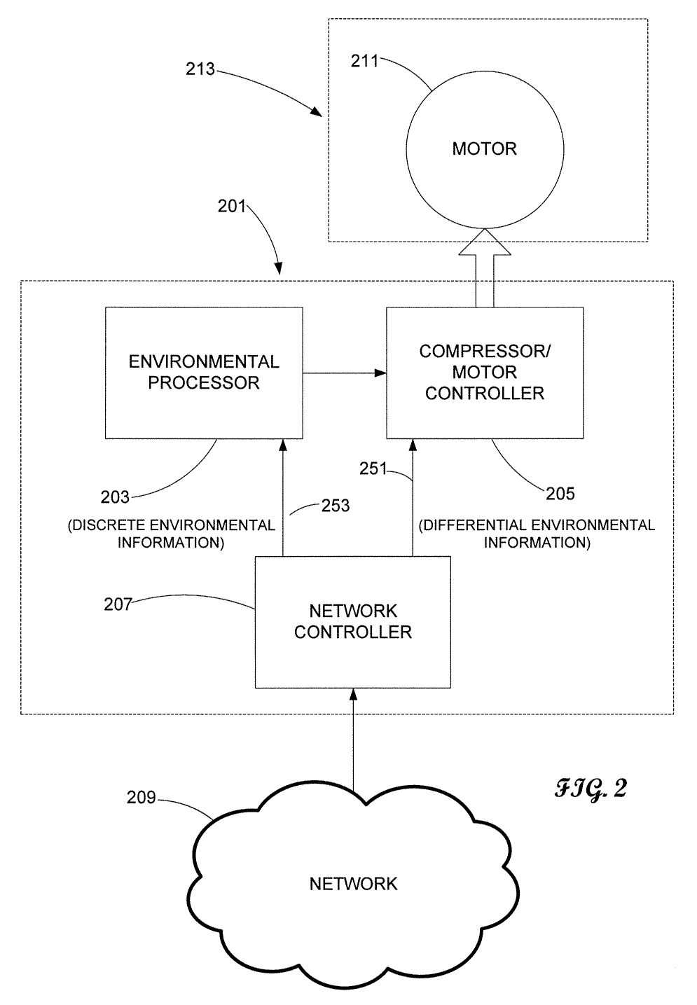

FIG. 2 shows integrated motor controller 201 with direct networking capability in accordance with an embodiment of the invention. With the emerging of wired and wireless networking technologies, temperature measurement may not be restricted to localized operation. Furthermore, with the advancement of microprocessor power and controller design, it may not be necessary to physically separate the functionality of environmental processor (thermostatic controller) 203 and compressor/motor controller 205. With embodiments of the invention, environmental processor 203 is integrated with compressor/motor controller 205 in a same enclosure. Integrated motor controller 201 integrates both controllers 203 and 205 to control motor 211, which may assume different forms. e.g., a compressor of an air conditioner or a blower motor of a furnace.

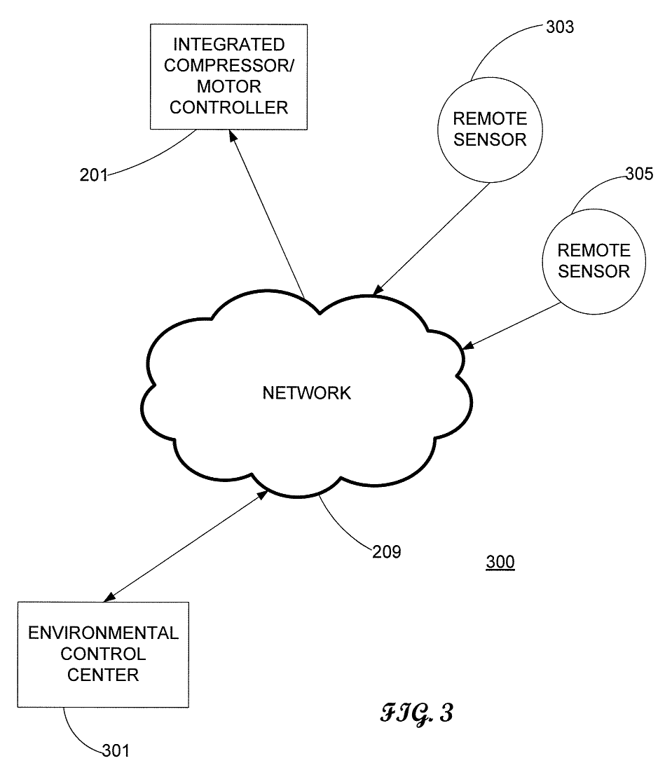

Integrated motor controller 201 may receive environmental information from different points of an environmentally-controlled space. Environmental information may include temperature and/or humidity information. Integrated motor controller 201 processes the environmental information received from network 209 (as will be further discussed with FIG. 3) through network controller 207 to control motor 211.

With embodiments of the invention, integrated controller 201 receives environmental information in two forms: differential environmental information 251 and discrete environmental information 253. Network controller 207 directs differential environmental information 251 to compressor/motor controller 205 and discrete environmental information 253 to environmental processor 203.

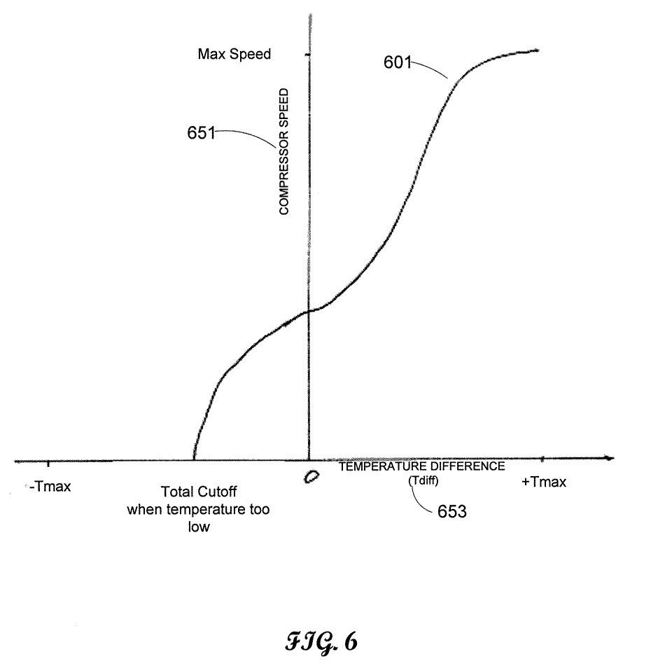

Differential environmental information 251 corresponds to a difference between a measured environmental factor (e.g., a measured temperature provided by remote sensor 303 as shown in FIG. 3) and a desired environmental factor environmental (e.g., a temperature set point which corresponds to a desired temperature of an environmentally-controlled room). Differential environmental information 251 may correspond to different environmental factors including temperature (measured temperature minus set temperature) and humidity (measured humidity minus set humidity). Differential environmental information 251 is processed by motor/compressor controller 205 for direct control of the motor 211. For example, if the temperature is higher in the summer, the compressor speed will increase proportionally. FIG. 6, as will be discussed, shows an exemplary relationship 601 between compressor speed 651 and temperature difference 653.

Environmental information 253 includes a set of environmental data including one or more measured environmental factors and one or more desired environmental factors. For example, remote sensors 303 and 303 may measure temperatures at different points of a large banquet room. Environmental processor 203 processes discrete environmental information 253 to determine differential environmental information or speed information. For example, environmental processor 203 may determine a temperature difference between a measured temperature and a temperature set point. Environmental processor 203 then provides the processed differential environmental information to motor/compressor controller 205 in order to control motor 211.

With embodiments of the invention, environmental processor 203 may process a plurality of measured temperatures by averaging the measured temperatures and subtracting a temperature set point from the averaged measure temperature. Moreover, the measured temperatures may be weighted to bias corresponding rooms. For example, the measured temperature for one room may be biased with respect to the measured temperature of another room. The weighting factors may vary over the time of day. For example, the measured living room temperature may be favored during the day hours while the measured bed room temperature may be favored during the night hours.

With embodiments of the invention, environmental processor 203 may convert the processed differential information to a determined speed for motor 211 and provide the speed value to motor controller 205.

With embodiments of the invention, environmental processor 203 includes one or more environmental sensors that provide measured environmental information, which may be combined with remotely-provided environmental information from network 209. Environmental processor 203 may process the measured environmental information to obtain differential environmental information.

Environmental system 213 affects an environmental factor of an environmentally-controlled space (e.g., a room or a portion of a building). Environmental system 213 may affect one or more environmental factors, including temperature, humidity, and air quality. Environmental system 213 may assume different forms, including a heating, ventilation, and air-conditioning (HVAC) unit. A HVAC unit is sometimes referred to as “climate control” and is particularly important in the design of medium to large industrial and office buildings such as sky scrapers and in marine environments such as aquariums, where humidity and temperature must all be closely regulated while maintaining safe and healthy conditions within.

The three functions of heating, ventilation, and air-conditioning are closely interrelated. All the functions seek to provide thermal comfort, acceptable indoor air quality, and reasonable installation, operation, and maintenance costs. HVAC systems can provide ventilation, reduce air infiltration, and maintain pressure relationships between spaces.

Because an environmentally-controlled space may be characterized by a variation of an environmental factor, it may be desirable to distribute one or more sensors (shown as remote sensors 303 and 305 as shown in FIG. 3) throughout the environmentally-controlled space.

Embodiments of the invention support a heating function in a HVAC system. When supporting the heating function a controller unit, in conjunction with a thermostat unit, couples with a variable blower motor of a furnace. The speed of the variable blower motor is varied in accordance with characteristics of the motor and thermodynamics considerations.

FIG. 3 shows network configuration 300 of an environmental control system with an embodiment of the invention. Integrated motor/compressor controller 201 may receive environmental information from different sources (e.g., remote sensors 303 and 305) and environmental control center 301 through network 209. Network 209 may comprise wire or wireless transport media. For example, wireless networking may support ZigBee or Z-Wave specifications, and wired networking may support Ethernet, CAN Bus, or Field Bus specifications.

With embodiments of the invention, environmental control center 301 determines environmental set points, which may be updated in accordance with meteorological conditions and demands on the electric utility. For example, if the electrical demands are excessive during a heat wave, environmental control center 301 may increase the temperature set point to decrease the electrical power consumption of environmental system 213.

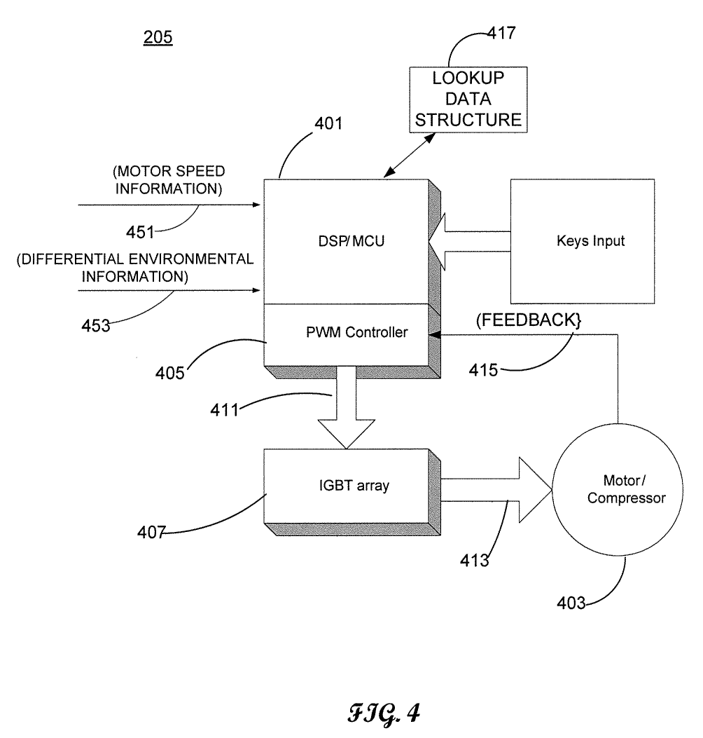

FIG. 4 shows compressor/motor controller 205 for controlling variable speed compressor/motor 403 in accordance with an embodiment of the invention. Microprocessor control unit (MCU) 401 scans data inputs 451 and 453 to obtain environmental information. Microprocessor control unit 401 may be coupled with a digital signal processor in order to facilitate calculations.

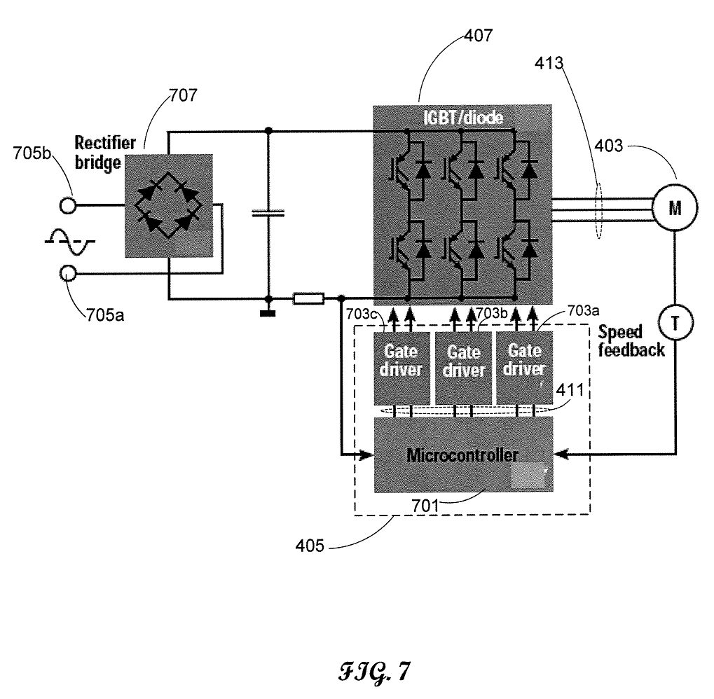

Microprocessor control unit 401 may access lookup data structure 417 in order to determine the compressor speed from the temperature difference (T_{diff}). (As will be discussed, the compressor speed is determined as a function of the temperature difference as shown in FIG. 6.) In order to obtain a desired efficiency, compressor 403 typically runs at a higher speed as the temperature difference becomes greater. When the compressor speed has been determined, microprocessor control unit 401 instructs PWM (pulse width modulated) controller 405 to drive IGBT (insulated-gate bipolar transistor) array 407 (via bus 411) so that compressor 403 runs at the desired compressor speed (over bus 413). PWM controller 405 is provided an indication of the actual compressor speed over feedback connection 415 in order to adjust the compressor speed to obtain the desired compressor speed. An exemplary embodiment will be further discussed with FIG. 7.

With the exemplary embodiment, compressor controller unit 205 functions with a traditional thermostat design but with software modifications as will be discussed.

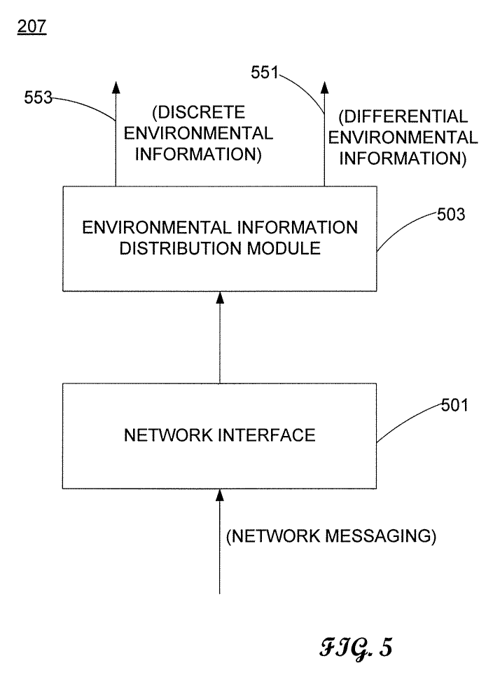

FIG. 5 shows network controller 207 in accordance with an embodiment of the invention. Network controller 207 interfaces with network 209 through network interface 501, which may receive environmental information from remote sensors 303 and 305 and environmental control center 301. Environmental information may be in different forms including differential environmental information and discrete environmental information. Environmental information distribution module 503 subsequently distributes the environmental information based on the form. For example, module 503 directs differential environmental information 551 to compressor/motor controller 205 and discrete environmental information to environmental processor 203.

FIG. 6 shows exemplary relationship 601 of compression speed 651 and temperature difference 653 (measured temperature minus temperature set point) in accordance with an embodiment of the invention. In general, the larger temperature difference 653, the faster motor 211 (as shown in FIG. 2) should operate.

With embodiments of the invention and referring to FIG. 4, microprocessor control unit 401 accesses lookup data structure 417 using an address determined by temperature difference 653 to obtain compression speed 651. Because the temperature difference typically varies from one sampling time period to another sampling time period, compressor speed 651 consequently varies with time.

FIG. 7 shows an exemplary configuration for controlling variable speed compressor 403 in accordance with an embodiment of the invention. In the exemplary embodiment, compressor 403 comprises a three-phase motor; however, other embodiments may support other types of motors, e.g., single-phase induction motors, DC motors, and universal motors.

Compressor 403 is powered by AC power lines 705a, 705b through rectifier bridge 707 and IGBT array 407. PWM controller 405 configures IGBT array 407 to control compressor 403 at the desired compressor speed. PWM controller 405 includes microcontroller 701 and gate drivers 703a-703c. The speed of compressor 403 is controlled by PWM controller 405, in which the voltage-to-frequency ratio is adjusted with a speed feedback configuration.

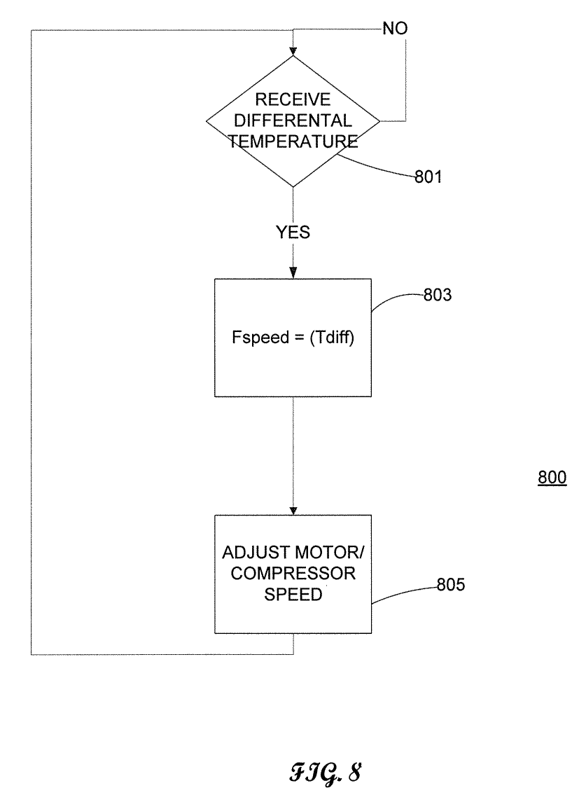

FIG. 8 shows flow diagram 800 for compressor/motor controller 205 in accordance with an embodiment of the invention. In step 801, compressor/motor controller 205 receives differential temperature information T_{diff} (measured temperature minus temperature set point) from through network 209. In step 803, compressor/motor controller 205 determines F_{speed} from T_{diff} from a predetermined relationship, e.g., relationship 601 as shown in FIG. 6. Compressor/motor controller 205 generates control signals to motor 211 in accordance with the determined motor speed.

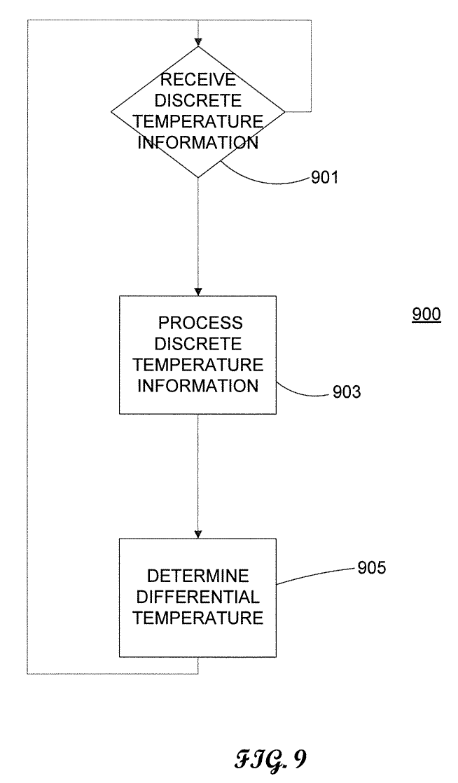

FIG. 9 shows flow diagram 900 for environmental processor 203 in accordance with an embodiment of the invention. In step 901, environmental processor 203 receives discrete temperature information through network 209. Environmental processor 203 subsequently processes the discrete information. For example, environmental processor 203 may subtract a temperature set point from a measured temperature. If a plurality of measured temperatures are provided by different temperature sensors (e.g., remote sensors 303 and 305 as shown in FIG. 3), environmental processor 203 may average the measured temperatures to obtain a average measured temperature in step 903. Environmental processor 203 obtains processed differential temperature information in step 905 by subtracting the temperature set point from the measured temperature.

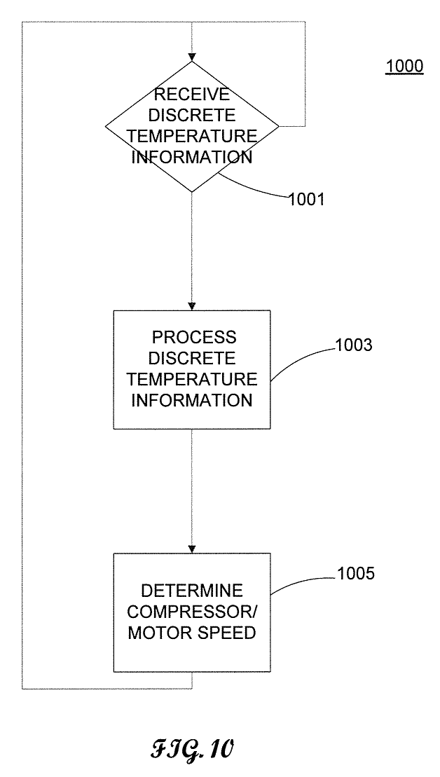

FIG. 10 shows flow diagram 1000 for environmental processor 203 in accordance with an embodiment of the invention. Steps 1001 and 1003 are similar to steps 901 and 903 as previously discussed. Moreover, environmental processor 203 may further determine the speed of motor 211 from the processed temperature information. For example, environmental processor 203 determines the motor speed from a predetermined relationship that maps the differential temperature to the determined motor speed and provides the motor speed to motor controller 205.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus for controlling an environmental system, the apparatus comprising:
a network controller configured to:
receive received differential environmental information through a network, the received differential environmental information indicative a measured environmental factor and a desired environmental factor; and
a motor controller configured to:
obtain the received differential environmental information from the network interface;
determine a desired speed of a variable speed motor of the environmental system based on the received differential temperature; and
adjusting an operating speed of the variable speed motor to approximate the desired speed.

2. The apparatus of claim 1, the network controller further configured to:
receive discrete environmental information through the network, the discrete environmental information including a first measured environmental factor and an environmental set point; and
the apparatus further comprising an environmental processor configured to:
determine processed differential environmental information from the discrete environmental information; and
provide the processed differential environmental information to the motor controller, wherein the motor controller determines the desired speed from the processed differential environmental information.

3. The apparatus of claim 2, the environmental processor further configured to:
determine the desired speed of the variable speed motor; and
provide the desired speed to the motor controller.

4. The apparatus of claim 1, the environmental system comprising a heating, ventilation, and air conditioning (HVAC) system.

5. The apparatus of claim 4, the measured environmental factor comprising a measured temperature and the desired environmental factor comprising a temperature set point.

6. The apparatus of claim 4, the measured environmental factor comprising a measured humidity and the desired environmental factor comprising a humidity set point.

7. The apparatus of claim 2, the discrete environmental information further comprising a second measured environmental factor, the environmental processor further configured to determine the processed differential information from the first environmental factor, the second environmental factor, and the environmental set point.

8. The apparatus of claim 1, the variable speed motor driving a compressor for circulating a refrigerant.

9. The apparatus of claim 2, the environmental processor being integrated with the motor controller in a single enclosure.

10. The apparatus of claim 2, the environmental processor further including a sensor that is configured to measure a second environmental factor.

11. A method for controlling an environmental system, the method comprising:
obtaining received differential environmental information through a network, the received differential environmental information indicative a measured environmental factor and a desired environmental factor;
determining a desired speed of a variable speed motor of the environmental system based on the received differential temperature; and
adjusting an operating speed of the variable speed motor to approximate the desired speed.

12. The method of claim 11, further comprising:
obtaining discrete environmental information through the network, the discrete environmental information including a first measured environmental factor and an environmental set point;
determining processed differential environmental information from the discrete environmental information; and
determining the desired speed from the processed differential environmental information.

13. The method of claim 12, the discrete environmental information further comprising a second measured environmental factor, the method further comprising:
determining the processed differential information from the first measured environmental factor, the second measured environmental factor, and the environmental set point.

14. The method of claim 13, the method further comprising:
averaging the first measured environmental factor and the second measured environmental factor to obtain an averaged measured environmental factor; and
subtracting the environmental set point from the averaged measured environmental factor to obtain the processed differential information.

15. The method of claim 11, the measured environmental factor provided by a remote sensor through the network.

16. The method of claim 11, the measured environmental factor comprising a measured temperature and the desired environmental factor comprising a temperature set point.

17. The method of claim 11, the measured environmental factor comprising a measured humidity and the desired environmental factor comprising a humidity set point.

18. The method of claim 11, the measured environmental factor comprising a measured temperature and the desired environmental factor comprising a temperature set point.

19. The method of claim 13, the first measured environmental factor comprising a first measured temperature value and the second measured environmental factor comprising a second measured temperature value, the environmental set point comprising a temperature set point, the method further comprising:
weighing the first measure temperature and the second measured temperature to obtain a first weighted measured temperature and a second weighed measured temperature;
averaging the first weighed measured temperature and the second weighed measured temperature to obtain an averaged measured temperature; and
subtracting the temperature set point from the averaged measured temperature to obtain the processed differential information.

20. The method of claim 19, further comprising:
determining weighting factors based on a time.

21. An apparatus for obtaining environmental information through a network, comprising:
a network interface configured to obtain differential environmental information and discrete environmental information through a network, the received differential environmental information indicative of a measured environmental factor and a desired environmental factor receive discrete environmental information through the network, the discrete environmental information including a first measured environmental factor and an environmental set point; and
an environmental information distribution module configured to provide the differential information to a motor controller and to provide the discrete environmental information to an environmental processor.

22. An apparatus for controlling an air conditioning unit, the air conditioning unit including a variable speed compressor, the system comprising:
a network controller configured to:
receive received differential temperature information through a network, the received differential temperature information corresponding to a difference of a measured temperature and a temperature set point; and
a compressor controller configured to:
obtain the received differential temperature information from the network interface;
determine a desired speed of a variable speed compressor of the air conditioning unit based on the received differential temperature; and
adjusting an operating speed of the variable speed compressor to approximate the desired speed.

23. The apparatus of claim 22, the network interface further configured to:
receive discrete temperature information through the network, the discrete temperature information including a measured temperature and a temperature set point; and
the apparatus further comprising an environmental processor configured to:
determine processed differential temperature information from the discrete temperature information; and
provide the processed differential environment information to the compressor controller, wherein the compressor controller determines the desired speed from the processed differential temperature information.

24. An apparatus for controlling a furnace, the furnace including a variable speed blower motor, the apparatus comprising:
a network controller configured to:
receive received differential temperature information through a network, the received differential temperature information indicative a measured temperature and a temperature set point; and
a motor controller configured to:
obtain the received differential temperature information from the network interface;
determine a desired speed of a variable speed blower motor of the furnace based on the received differential temperature; and
adjusting an operating speed of the variable speed blower motor to approximate the desired speed.

25. The apparatus of claim 24, the network interface further configured to:
receive discrete temperature information through the network, the discrete temperature information including a measured temperature and a temperature set point; and
the apparatus further comprising an environmental processor configured to:
determine processed differential temperature information from the discrete temperature information; and
provide the processed differential temperature information to the motor controller, wherein the motor controller determines the desired speed from the processed differential temperature information.
